(19) United States
(12) Patent Application Publication
(10) Pub. No.: US 2012/0039574 A1
(43) Pub. Date: Feb. 16, 2012

(54) CONNECTOR ASSEMBLY FOR OPTICAL AND ELECTRICAL TRANSMITTING

(75) Inventors: CHI-NAN LIAO, New Taipei (TW); HSIEN-CHU LIN, New Taipei (TW)

(73) Assignee: HON HAI PRECISION INDUSTRY CO., LTD., New Taipei (TW)

(21) Appl. No.: 13/208,356

(22) Filed: Aug. 12, 2011

(30) Foreign Application Priority Data
Aug. 12, 2010 (TW) 99126853

(51) Int. Cl. G02B 6/36

(52) U.S. Cl. 385/93

(57) ABSTRACT

An connector assembly (100) includes an insulative housing (1) having a main portion (11) and a tongue portion (12) extending forwardly from the main portion, a cavity (121) defined in the tongue portion; a plurality of terminals (2) retained in the insulative housing; an optical module (3) accommodated in the cavity, said optical module having a base portion (30) and a plurality of lenses (33) combined with the base portion, and the base portion having a top surface and a bottom surface, and the top surface with an identifying color.

### FIELD OF THE INVENTION

The present invention generally relates to a connector assembly, and more particularly to a connector assembly adapted for optical and electrical transmitting.

### DESCRIPTION OF PRIOR ART

In many of today's processing systems, such as personal computer (PC) systems, there exist universal serial bus (USB) ports for connecting various USB devices. Different standards of USB technology for different bandwidths have been launched by USB-IF supported by some of world largest IT companies. For instance, Universal Serial Bus Specification, revision 1.1 devices are capable of operating at 12 Mbits/second(Mbps). Universal Serial Bus Specification, revision 2.0 devices are capable of operating at 480 Mbps. Universal Serial Bus Specification, revision 3.0 devices are capable of operating at higher speed also accepted by market, gradually. However, as technology progresses engineers are constantly striving to increase operating speeds.

For example, CN Pub. Pat. No. 101345358 published on Jan. 14, 2009 discloses an optical USB connector assembly which has a fiber device added to a USB connector assembly. The fiber device has a number of fibers connected with lenses embedded in the USB connector. Thus, optical signal transmits along a first fiber and is expanded/magnified by a first lens terminated to the first fiber, and then shrunk by a second lens and runs through second fiber of a complementary connector. However, as the lenses are relative small and discrete from each other and not easily to be assembled to the USB connector.

Hence, an improved connector assembly is highly desired to overcome the aforementioned problems.

### SUMMARY OF THE INVENTION

Accordingly, an object of the present invention is to provide an easily manufactured connector assembly for optical and power transmitting.

In order to achieve the object set forth, a connector assembly in accordance with the present invention comprises an insulative housing having a main portion and a tongue portion extending forwardly from the main portion, a cavity defined in the tongue portion; a plurality of terminals retained in the insulative housing; an optical module accommodated in the cavity, said optical module having a base portion and a plurality of lenses combined with the base portion, and the base portion having a top surface and a bottom surface, and the top surface with an identifying color.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of the connector assembly;

FIG. 2 is an exploded, perspective view of FIG. 2;

FIG. 3 is similar to FIG. 2, but viewed from another aspect; and

FIG. 4 is a partially assembled view of the connector assembly.

### DETAILED DESCRIPTION OF PREFERRED EMBODIMENTS

Reference will now be made in detail to the preferred embodiment of the present invention.

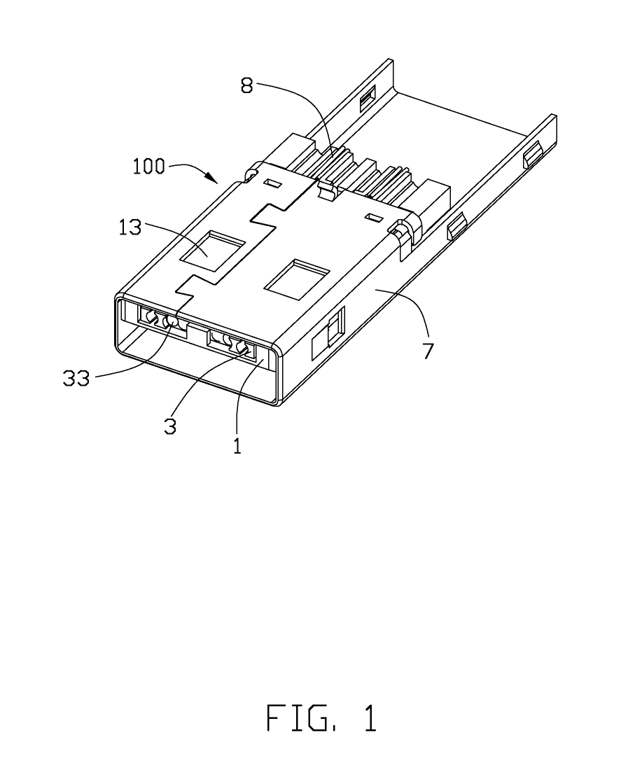

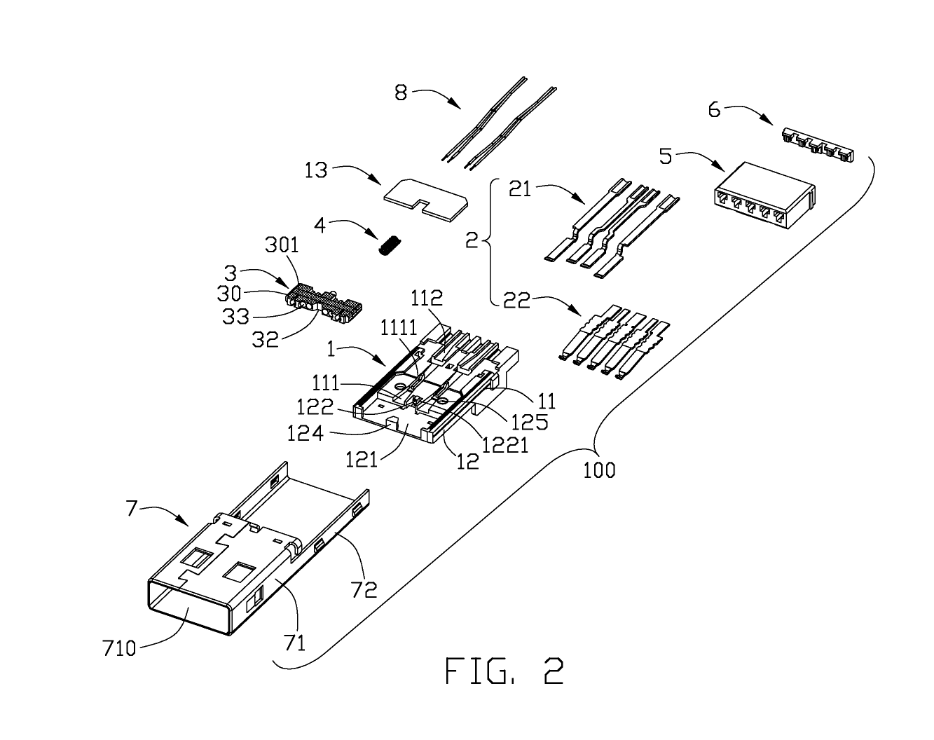

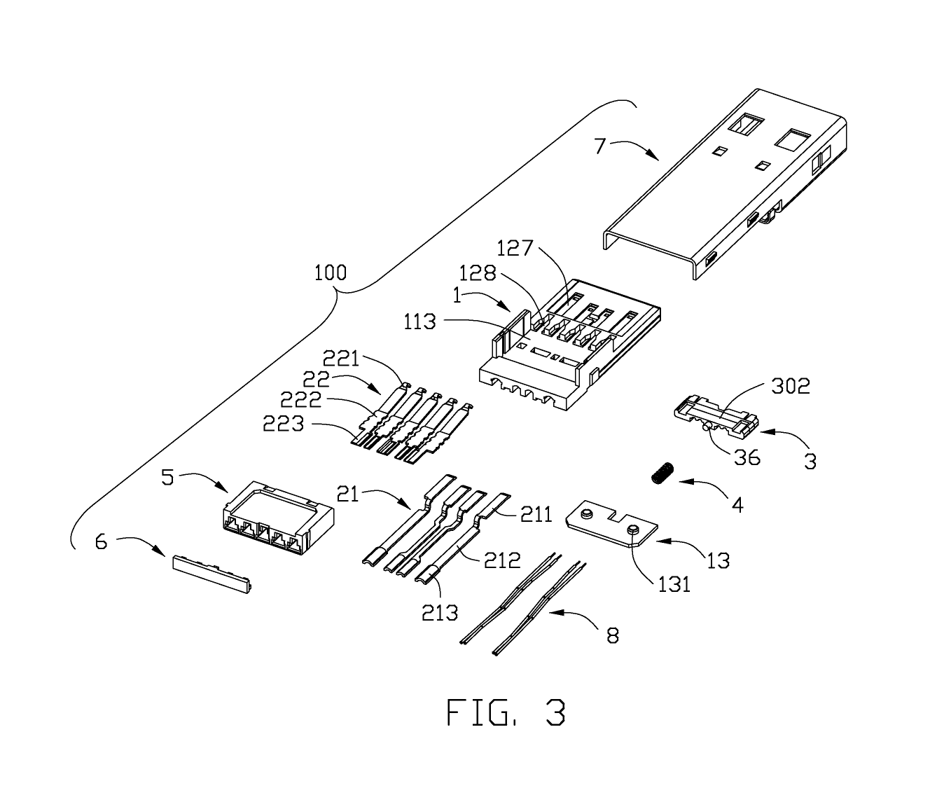

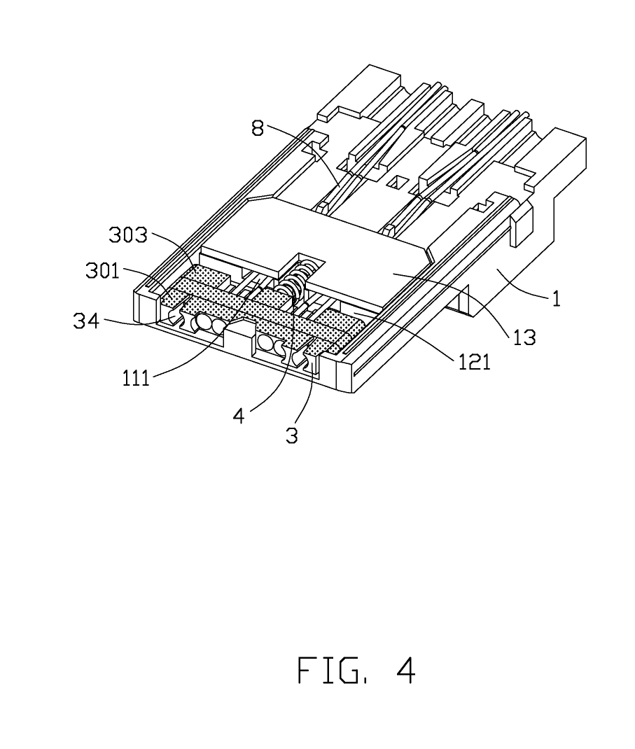

Referring to FIGS. 1-4, a connector assembly 100 in accordance with the present invention comprises an insulative housing 1, a plurality of terminals 2 retained in or supported by the insulative housing 1, an optical module 3 mounted to the insulative housing 1, an elastic member 4 sandwiched between the insulative housing 1 and the optical module 3 so as to forwardly bias the optical module 3, a terminal seat 5, a spacer 6, a metallic shell 7 shrouding the insulative housing 1, a number of fibers 8 connecting with the optical module 3.

The insulative housing 1 includes a main portion 11 and a tongue portion 12 extending forwardly from the main portion 11.

There are two fiber passages 111 located in a top side of a back segment of the tongue portion 12 and a front segment of the main portion 11. Each fiber passage 111 is tapered shape along front-to-back direction. A front part is wider than a back part of the fiber passage 111. There is a longitudinal rib 1111 formed in a middle part of the fiber passage 111 and the rib 1111 also extends along the front-to-back direction. There are two retaining slots 112 located in a back segment of the main portion 11. The retaining slot 112 is also configured to be tapered shape along the front-to-back segment. Furthermore, the retaining slot 112 communicates with the fiber passage 111. The fiber passage 111 is deeper than the retaining slot 112. There is a recess 113 located in a bottom side of the main portion 11. The terminal seat 5 is accommodated in the recess 113. There is a cavity 121 defined in a top side of a front segment of the tongue portion 12. The cavity 121 is deeper than the fiber passage 111. Also, there is a groove 122 defined in the tongue portion 12 and disposed behind the cavity 121. The groove 122 communicates with the cavity 121 too. A positioning member 1221 is located in the groove 122 and projects forwardly. The positioning member 1221 may be a post or a protrusion.

The elastic member 4 may be a coil spring. A rear segment of the elastic member 4 is accommodated in the groove 122, with the positioning member 1221 inserted therein. There is a V-shaped stopper 124 located in middle segment of a front end of the tongue portion 12. A set of first terminal grooves 127 and a set of second terminal grooves 128 defined in a bottom side of the tongue portion 12. The first terminal grooves 127 are disposed in front of the second terminal grooves 128.

An arrangement of the terminals 2 is in accordance with USB 3.0 standard. The terminals 2 are divided into a set of first terminals 21 and a set of second terminals 22. The first terminals 21 and the second terminals 22 are separated into two distinct rows along the front-to-back direction.

The set of first terminals 21 have four contact members arranged in a row along the transversal direction. Each first terminal 21 substantially includes a planar retention portion 212 supported by a bottom surface of the recess 113, a mating portion 211 raised upwardly and extending forwardly from the retention portion 212 and received in the corresponding first terminal groove 127, and a tail portion 213 extending rearward from the retention portion 212. Furthermore, the mating portion 211 and the tail portion 213 are disposed at opposite sides (bottom side and top side) of the insulative housing 1.

The set of second terminals 22 have five contact members arranged in a row along the transversal direction and combined with the terminal seat 5. The set of second terminals 22 are separated into two pairs of signal terminal for transmitting differential signals and a grounding terminals disposed between the two pair of signal terminals. Each second terminal 22 includes a planar retention portion 222 received in the terminals seat 5, a curved mating portion 221 extending forward from the retention portion 222 and disposed beyond a front surface of the terminal seat 5, and a tail portion 223 extending rearward from the retention portion 222 and disposed behind a back surface of the terminal seat 5. The spacer 6 is assembled to the terminal seat 5, with a number of ribs (not numbered) thereof inserted into the grooves (not numbered) of the terminal seat 5 to position the second terminals 22. The mating portion 221 is deformable along a upper-to-down direction and can enter the corresponding second terminal groove 128 while pressed by its counterpart of a complementary connector.

The optical module 3 includes four lens members 33 arranged in juxtaposed manner and combined with a base portion 30. The base portion 30 further defines a cutout 32 in middle segment of a front side thereof A mounting post 36 protrudes backwardly from a middle of a back side of the base portion 30. The base portion 30 is made of transparent material, such as plastic material. The base portion 30 has a top surface (first surface) 301 and an opposite bottom surface (second surface) 302. The top surface 301 is painted with a relative dark color or other indentifying color distinct from the bottom surface 302, so as to identify itself from the bottom surface 302. A marker or other instrument may be used for painting or coloring the top surface 301 of the base portion 30.

The optical module 3 is accommodated in the cavity 121, with the top side 301 of the base portion 30 facing upwardly. The mounting post 36 is inserted into a front segment of the elastic member 4, and the optical module 3 is pushed forwardly and floatable within the cavity 121. The stopper 124 is accommodated in the cutout 32 to prevent the optical module 3 escaping from the insulative housing 1.

The fibers 8 extend into fiber passages 111 via the retaining slots 112 and are respectively coupled to the lenses 33 of the optical module 3. As the fiber passages 111 are configured to be tapered shape, thus there is enough space for the fibers 8 to move therein. In addition, the fibers 8 are properly inhibited within the fiber passages 111. There are two fibers 8 received in one of the fiber passages 111, and the two fibers 8 are spaced apart from each other by the rib 1111, therefore, they do not twist together. There is also a cap 13 mounted to the insulative housing 1 to shield the fiber passages 111 and the fibers 8 are positioned in the fiber passages 111. The cap 13 has two positioning members 131 formed at a bottom surface thereof and inserted into positioning holes 125 defined in the insulative housing 1. As the optical module 3 and the terminals 2 are arranged at opposite sides of the insulative housing 1, hence it facilitates manufacturing proceed.

The metallic shell 7 includes a frame 71 and a U-shaped portion 72 connected to the frame 71. The frame 71 has a rectangular shaped hollow 710.

The insulative housing 1 is assembled to the metallic shell 7, with the tongue portion 12 received in the hollow 710 of the frame 71, the main portion 11 accommodated in the U-shaped portion 72.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A connector assembly, comprising:
an insulative housing having a main portion and a tongue portion extending forwardly from the main portion, a cavity defined in the tongue portion;
a plurality of terminals retained in the insulative housing;
an optical module accommodated in the cavity, said optical module having a base portion and a plurality of lenses combined with the base portion, and the base portion having a top surface and a bottom surface, and the top surface with an identifying color.

2. The connector assembly as recited in claim 1, wherein the base portion of the optical module is made of transparent material.

3. The connector assembly as recited in claim 2, wherein the base portion of the optical module is made of plastic material.

4. The connector assembly as recited in claim 1, wherein the identifying color is a dark color distinct from the bottom surface of the base portion.

5. The connector assembly as recited in claim 1, wherein there are plurality of fibers respectively coupled to the lenses of the optical module.

6. The connector assembly as recited in claim 5, wherein the insulative housing defining at least one fiber passage located behind the cavity and communicating with the cavity.

7. The connector assembly as recited in claim 6, wherein the fiber passage is of tapered shape along a front-to-back direction.

8. The connector assembly as recited in claim 1, wherein there is a coil spring sandwiched between the insulative housing and the optical module.

9. The connector assembly as recited in claim 8, wherein there is positioning member projecting forwardly from the tongue portion and inserted into a rear portion of the coil spring.

10. The connector assembly as recited in claim 9, wherein there is a groove defined in the tongue portion to receive the positioning member therein.

11. The connector assembly as recited in claim 10, wherein the rear portion of the coil spring is accommodated in the groove.

12. The connector assembly as recited in claim 9, wherein there is a mounting post formed on a back side of the base portion of the optical module and inserted into a front portion of the coil spring.

13. The connector assembly as recited in claim 1, wherein the terminals and the optical module are arranged at opposite sides of the insulative housing.

14. The connector assembly as recited in claim 1, wherein the terminals are divided into a set of first terminals and a set of second terminals.

15. The connector assembly as recited in claim 10, wherein the first terminals having mating portions offset mating portions of the second terminals along a front-to-back direction.

16. The connector assembly as recited in claim 1, wherein the optical module is floatable inside the cavity.

17. A connector assembly comprising:
an insulative housing defining a receiving cavity around a front mating port along a front-to-back direction;
an optical module configured to be snugly received in the receiving cavity and to be self-symmetrical with regard to a centerline thereof in said front-to-back direction so that said optical module is allowed to be inserted into the receiving cavity either in a normal manner or an upside-down manner; wherein
a top face of the optical module and a bottom face of the optical module provide different identification marks to assure correction orientation of the optical module with regard to the housing.

18. The connector assembly as clamed in claim 17, wherein the different identification marks includes a color applied upon at least a portion of the top face.

19. The connector assembly as claimed in claim 19, wherein the bottom face is transparent.

20. A connector assembly comprising:
an insulative housing defining a receiving cavity around a front mating port along a front-to-back direction;
an optical module configured to be snugly received in the receiving cavity and to be self-symmetrical with regard to a centerline thereof in said front-to-back direction so that said optical module is allowed to be inserted into the receiving cavity either in a normal manner or an upside-down manner; wherein
a colorful mark is provided upon one of exterior faces of the optical module to assure correction orientation of the optical module with regard to the housing.
